(19) United States
(12) Patent Application Publication
(10) Pub. No.: US 2007/0157795 A1
(43) Pub. Date: Jul. 12, 2007

(54) METHOD FOR GENERATING A VISUALIZING MAP OF MUSIC

(75) Inventor: Chien-Yu Hung, Banciao City (TW)

Correspondence Address: KUSNER & JAFFE;HIGHLAND PLACE SUITE 310, 6151 WILSON MILLS ROAD, HIGHLAND HEIGHTS, OH, 44143, US

(73) Assignee: Ulead Systems, Inc.

(21) Appl. No.: 11/617,187

(22) Filed: Dec. 28, 2006

(30) Foreign Application Priority Data
Jan. 9, 2006 (TW) 095100816

(51) Int. Cl. G10H 1/00

(52) U.S. Cl. 84/600

(57) ABSTRACT

The present invention provides a method for generating a visualizing map of music in accordance with the identifiable features of the music. First, the music would be divided into plural segments, and the length of each segment is preferably identical. After that, an audio analysis is executed to determine the mood types of these segments. Each mood type may be determined by certain parameters, such as tempo value and articulation type. Besides, every mood type corresponds to a certain visualizing expression, and the correspondence can be defined in advance and looked up in a table for example. Eventually, the visualizing map of the music is generated according to the mood types and the distribution of visualizing expressions.

### FIELD OF THE INVENTION

The present invention is related to a method for visualizing music. More particularly, the present invention relates to a method of generating a visualizing map of music by executing an audio analysis.

### BACKGROUND OF THE INVENTION

While people enjoy music from a computer or other media device, the display generally presents certain visual effects, such as colorful ripples or waves. For example, the Media Player of Microsoft™ and the MP3 player Winamp™ both provide some visual effects. Conventionally, traditional visual effects are displayed randomly without considering the features or types of the played music. Therefore, the user could merely see the changes of the visual effects while listening to the music, but is unable to record the visualizing map of music as a static visualizing feature.

Current computers possess various powerful abilities for playing the music while comparing with the walkman® or the hi-fi equipment. The traditional method of presenting visual effects merely utilizes little loading capacity of the computer which is undoubtedly a waste. There have been a great number of papers discussing the audio analysis, such as Hiraga R., Matsuda N., “Graphical expression of the mood of music,” pp. 2035-2038, Vol. 3, ICME, 27-30 Jun. 2004; Changsheng Xu, Xi Shao, Maddage N. C., Kankanhalli M. S., Qi Tian, “Automatically Summarize Musical Audio Using Adaptive Clustering,” pp. 2063-2066, Vol. 3, ICME, 27-30 Jun. 2004; Yazhong Feng, Yueting Zhuang, Yunhe Pan, “Music Information Retrieval by Detecting Mood via Computational Media Aesthetics,” pp. 235-241, WI, 13-17 Oct. 2003; Masataka Goto, Yoichi Muraoka, “Real-time beat tracking for drumless audio signals: Chord change detection for musical decisions,” pp. 311-335, Speech Communication 27, 1999; Jonathan Foote, “Automatic Audio Segmentation Using A Measure of Audio Novelty,” Proc. IEEE Intl Conf., Multimedia and Expo, ICME, IEEE, vol. 1, pp. 452-455, 2000; Ye Wang, Miikka Vilermo, “A Compressed Domain Beat Detector Using MP3 Audio Bitstreams,” Proc. of the 9th ACM International Conference on Multimedia, pp. 194-202, Sep. 30-Oct. 5, 2000; and Masataka Goto, “SmartMusicKIOSK: Music Listening Station with Chorus-Search Function,” Proceedings of the 16th annual ACM symposium on User interface software and technology, Volume 5, Issue 2, pp. 31-40, November 2003.

Since the audio analysis is commonly used nowadays, the result of the audio analysis can properly be applied in music playback. Besides, the visual effects should preferably reflect the content of the music to make the display meaningful instead of insignificant embellishment.

### SUMMARY OF THE INVENTION

In view of the aforementioned problems, the present invention provides a method for visualizing music as well as generating the visualizing map. The visualizing expression in visualizing map exactly reflects the feature of the music, and the user could easily recognize the nature of the music by “viewing” the visual effects. Besides, the visualizing map of the segment could be summarized as a representative visualizing expression. By using such representative visualizing expression, the user could sort, search or classify the music in a more convenient way.

According to one respect of the present invention, a method for generating a visualizing map of music is provided. First, the music would be divided into plural segments, and the length of each segment is preferably identical. After that, an audio analysis is executed to determine the mood type of each segment. The mood type may be determined by referring to some parameters, such as musical tempo, rhythm distribution (including the count and density), and articulation type. Besides, every mood type corresponds to a certain visualizing expression, and such correspondence can be defined beforehand, for example, by a look-up table. Eventually, the visualizing map of the music is generated according to the mood types and distribution of visualizing expressions.

According to another respect of the present invention, a method for visualizing music is provided. First, the music would be divided into plural segments, and the length of each segment is preferably identical. Consequently, the segments can be individually or jointly analyzed to obtain identifiable features. The identifiable features include musical tempo, rhythm distribution or articulation type. After that, the visualizing expression of every segment is determined by above mentioned identifiable features. Finally, the visualizing expressions would be presented in order while the music is played.

### BRIEF DESCRIPTION OF THE DRAWINGS

FIG. 1 is a flow chart showing a method of generating the visualizing map of music according to the preferred embodiment of the present invention.

FIG. 2 is a flow chart showing the procedure of the audio analysis according to the preferred embodiment of the present invention.

FIG. 3 has five examples of the present invention showing visualizing maps of music.

FIG. 4 is a flow chart showing a method of visualizing music according to another embodiment of the present invention.

### DETAILED DESCRIPTION OF THE PREFERRED EMBODIMENT

The present invention is described with the preferred embodiments and accompanying drawings. It should be appreciated that all the embodiments are merely used for illustration. Although the present invention has been described in terms of a preferred embodiment, the invention is not limited to this embodiment. The scope of the invention is defined by the claims. Modifications within the spirit of the invention will be apparent to those skilled in the art.

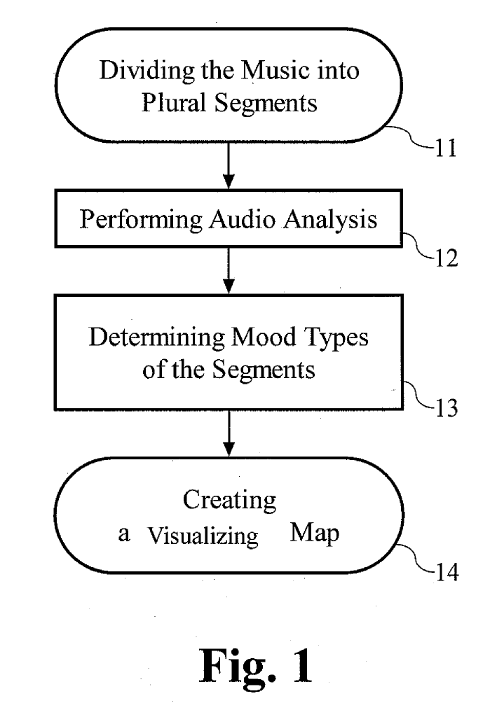

Please refer to FIG. 1, which is a flow chart showing a method of generating the visualizing map of music according to the preferred embodiment of the present invention. In order to visualize the music, the music should be properly divided into plural segments, as shown in step 11. Generally, the greater the number of the divided segments is, the more accurate the following analysis would be. However, if the segment is too short, an identifiable feature is hard to be obtained for presenting its characteristics thereof. In the present invention, each segment preferably has an identical length by at least few seconds (e.g. 5 seconds).

After that, the audio analysis would be executed to obtain certain identifiable features of each segment, as set forth in step 12. In one embodiment, the beat points of the segments from the music are obtained by the audio analysis and such beat points represent that the chord change probability has exceeded some threshold. The detailed description of the audio analysis is described in the following paragraph. With the beat points or the low-level features of each segment, the mood type of each segment could be determined in step 13. An audio analysis is executed for obtaining the low-level features. For example, the distribution, including the density and the count, of beat points in the segment could be used to calculate the tempo value of that segment. The tempo value would then be a reference for determining the mood type. Moreover, the articulation type of the segment may also be another reference for determining the mood type. The articulation type may be a ratio of the “staccato” and the “legato.” Since the detection ways of the articulation type are various and well-known in the art, the detailed description thereof is omitted herein to avoid obscuring the scope of the present invention. In the preferred embodiment, the articulation type is determined by detecting the relative silence within the segments.

Please refer to Table 1, which illustrates an example of the mood type determined by the tempo value and the articulation type. As can be seen from Table 1, when the tempo value reveals that the tempo of the segment is fast and the articulation type tends to be staccato, the mood type is preferably defined as “Happiness.” Besides, the mood type could be defined as “Sadness” if the tempo value is slow and the articulation type is legato. It should be appreciated that Table 1 is merely cited for exemplification, instead of limitation. The mood type can be also determined by other elaborate ways in other embodiments, such as creating a more complicated table in order to consider more parameters, or further categorize the tempo value or articulation type.

TABLE 1

| | |
|---|---|
| Tempo Value | Articulation Type |

| | Fast | Slow | Staccato | Legato |
|---|---|---|---|---|
| Happiness | ◯ | X | ◯ | X |
| Sadness | X | ◯ | X | ◯ |
| Anger | ◯ | X | X | ◯ |
| Fear | X | ◯ | ◯ | X |

A related art, U.S. patent application Ser. No. 11/034,286 assigned to the identical assignee is incorporated herein for reference. The reference disclosed a method for generating a slide show with audio analysis, and one embodiment of the present invention is applied with similar audio analysis of the cross-reference.

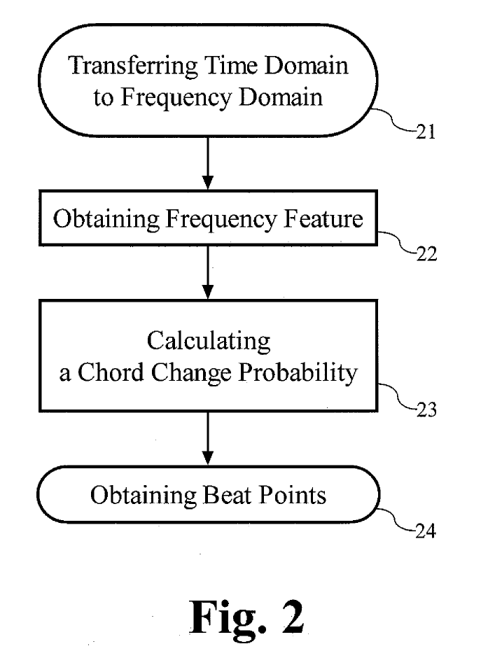

Please refer to FIG. 2, which illustrates a flow of the audio analysis. To analyze the audio data, the spectrogram first should be obtained. The segment of each audio signal is transferred to the frequency domain by using the Fast Fourier Transform (FFT). That is, the wave feature of the time domain is transferred to the energy feature of the frequency domain, as shown in step 21. Next, in step 22, the frequency feature would be obtained. Since the energy value in spectrogram is measured in dB, it is required to convert the complex value (i.e. audio source data) by FFT as shown in Formula 1 into dB form. The Formula 1 is preferably applied herein.

Energy Value_{(dB)}=20×log [sq(FFT(source data))] Formula 1

Subsequently, the energy value would be divided into plural sub-bands according to different frequency domains. The data within these sub-bands are sliced into predetermined time periods, and the dominant frequency of each period is detected. The dominant frequency is determined according to the energy value of each sub-band. Consequently, the frequency feature is obtained.

With the frequency feature, the chord change probability could be calculated by comparing the dominant frequencies of adjacent periods, as shown in step 23. Finally, in step 24, the beat points of the audio data are obtained according to the chord change probability. For example, as the chord change probability of certain period is greater than zero, one point in that period would be taken as a beat point.

Referring back to FIG. 1, after the mood type of each segment is determined, a visualizing map would be generated, as set forth in step 14. Such visualizing map could be utilized to visualize the music. In other words, while the music is played, a display could present certain visual effects or patterns in accordance with the visualizing map. For example, every segment could be allocated with some visualizing expression, and the visualizing map records the distribution. In the embodiment, every mood type is designated with a corresponding visualizing expression in advance, and the corresponding visualizing expression would be allocated to each segment according to the mood type thereof. The visualizing map is constituted by the visualizing expressions allocated to all segments of music.

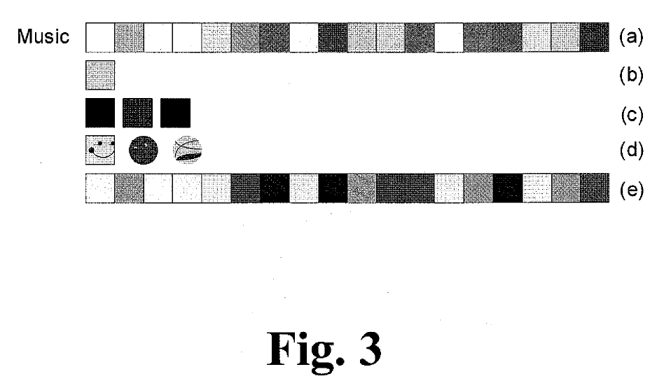

Please refer to FIG. 3, which presents embodiments of the visualizing maps of music. Five examples, (a), (b), (c), (d) and (e), are provided in FIG. 3, and each visualizing map is comprised of several visualizing expressions. Generally, the number of the visualizing expressions of a visualizing map is equal to that of the segments. The visualizing expressions may include colors, texture patterns, emotion symbols or value of brightness. In visualizing map (a), the music is divided into eighteen segments, and each segment is allocated with a color. While the music is played, the display of computer, player or television may show these colors in order to provide proper visual effects of the music. Furthermore, the information maintained in the visualizing map, including visualizing expressions corresponding to certain mood types, could be summarized to a single visualizing expression, namely the representative or summarized visualizing map, representing the entire music. For example, visualizing map (a) may be summarized to a representative visualizing expression (b), which is yellow. In this way, the music could be easily and appropriately categorized. With this categorized information, the user may conveniently classify and search music with similar identifiable features.

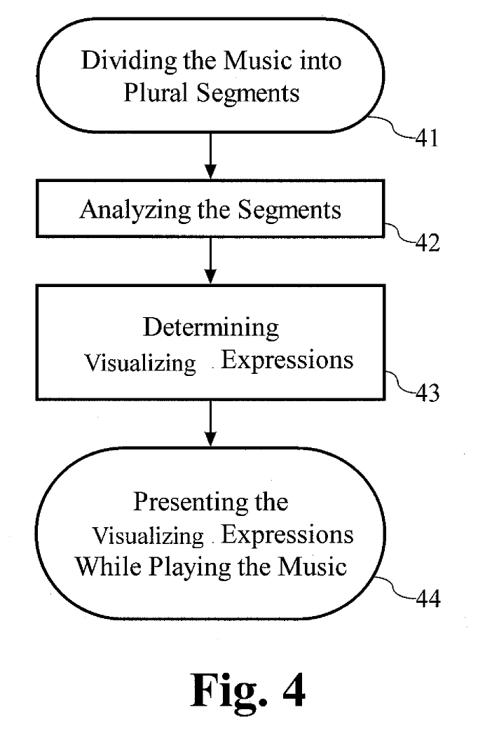

Besides, the color of each segment may be determined by pre-constructing a corresponding table of mood types and colors. The mood-color table includes the corresponding information between the colors and the mood types. In U.S. Pat. No. 6,411,289, entitled “Music visualization system utilizing three dimensional graphical representations of musical characteristics,” an example of such mood-color table is disclosed in FIG. 4F thereof, which is cited herein for reference. However, the mood-color table mentioned above is merely described for illustration, instead of limitation. Other suitable ways for determining the colors could still be applied in other embodiments of the present invention.

Besides color, the visualizing map may also be comprised of other kinds of visualizing expressions, such as texture patterns in visualizing map (c), emotion symbols in visualizing map (d) or values of brightness in visualizing map (e).

FIG. 4 is a flow chart, which shows another embodiment of the present invention. The method for visualizing music provided in FIG. 4 is similar with that for FIG. 1; so some details are omitted herein for avoiding redundancy. In step 41, the music is divided into plural segments, and these segments are individually or jointly analyzed for obtaining the identifiable features, such as tempo value, rhythm distribution (including count and density) or articulation type, as shown in step 42. With the identifiable features, segments are allocated with visualizing expressions accordingly in step 43. Finally, in step 44, the visualizing expressions would be seen on the display of computer, player or television while the music is played.

The present invention presents visualizing effects or expressions while the music is played. Since such visualizing effects or expressions are determined by the identifiable features of the music, the listeners' reception and feeling could be perfectly simulated and then played on the display. Therefore, the visualizing effects or expressions provided by the present invention would be quite significant to the listeners.

As is understood by a person skilled in the art, the foregoing preferred embodiments of the present invention are illustrated of the present invention rather than limiting of the present invention. It is intended to cover various modifications and similar arrangements included within the spirit and scope of the appended claims, and the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

Having described the invention, the following is claimed:

1. A method for generating a visualizing map of music comprises the steps of:
dividing said music into plural segments;
executing an audio analysis for determining mood types of said segments; and
generating said visualizing map of said music according to said mood types.

2. The method as claimed in claim 1, wherein said method further comprises the step of:
processing low-level features of said segments for determining said mood types, wherein said low-level features are obtained by said audio analysis.

3. The method as claimed in claim 1, wherein said method further comprises the step of:
designating a mood type to each visualizing expression, and allocating each said visualizing expression to one of said segments according to said mood types of said plural segments.

4. The method as claimed in claim 3, wherein said visualizing map can comprise plural visualizing expressions of said segments.

5. The method as claimed in claim 3, wherein said visualizing expression comprises color, texture pattern, emotion symbol or value of brightness.

6. The method as claimed in claim 3, wherein said method further comprises the step of:
determining a visualization summary according to the distribution of said visualizing expression; and
generating a summarized visualizing map according to said visualization summary.

7. The method as claimed in claim 6, wherein said visualizing map comprises said distribution, and said distribution is summarized to determine said visualization summary.

8. The method as claimed in claim 1, wherein the lengths of said segments are substantially identical.

9. The method as claimed in claim 1, wherein said audio analysis comprises:
transferring the wave feature of a time domain to the energy feature of a frequency domain for obtaining an energy value;
dividing said energy value into plural sub-bands;
calculating a chord change probability of each period according to a dominant frequency of adjacent period, wherein the length of said period is predetermined;
obtaining beat points according to said chord change probability; and
obtaining a tempo value according to a density of said beat points.

10. The method as claimed in claim 9, wherein said dominant frequency is determined according to the energy value of every said sub-band.

11. The method as claimed in claim 9, wherein said mood types are determined according to the distribution of said beat points in said segments.

12. The method as claimed in claim 9, wherein said mood types are determined according to said tempo value of said segments.

13. The method as claimed in claim 1, wherein said mood types are determined according to articulation types of said segments, and said articulation types are detected in said audio analysis.

14. The method as claimed in claim 13, wherein said articulation types are determined by detecting a relative silence of said music.

15. A method for visualizing music, comprising the steps of:
dividing said music into plural segments;
analyzing said segments to obtain identifiable features;
determining the visualizing expressions of said segments according to said identifiable features; and
presenting said visualizing expressions in order while said music is played.

16. The method as claimed in claim 15, which further comprises:
executing an audio analysis for obtaining low-level features, and processing said low-level features for obtaining said identifiable features.

17. The method as claimed in claim 15, which further comprises:
designating each of said identifiable features to a visualizing expression, and allocating said visualizing expression to each of said segments according to said identifiable features of said segments.

18. The method as claimed in claim 15, wherein said music is analyzed by steps comprising:
transferring wave features of a time domain to energy features of a frequency domain for obtaining an energy value;
dividing said energy value into plural sub-bands;
calculating a chord change probability of each period according to a dominant frequency of adjacent period, wherein the length of said period is predetermined;
obtaining beat points according to said chord change probability; and
obtaining a tempo value according to a density of said beat points.

19. The method as claimed in claim 18, wherein said dominant frequency is determined according to energy value of every said sub-band.

20. The method as claimed claim 15, wherein said identifiable features are determined according to the distribution of said beat points, an articulation type or a tempo value.

21. The method as claimed in claim 20, wherein said articulation type is determined by detecting a relative silence of said music.

22. The method as claimed in claim 15, wherein said visualizing expressions include a color, a texture pattern, an emotion symbol or a value of brightness.

23. The method as claimed in claim 15, wherein said music is played by a computer or player and said visualizing expressions are presented on a display of said computer or player.
